(19) United States
(12) Patent Application Publication
(10) Pub. No.: US 2007/0289536 A1
(43) Pub. Date: Dec. 20, 2007

(54) IN-LINE APPARATUS AND REAL-TIME METHOD TO DETERMINE MILK CHARACTERISTICS

(75) Inventors: James Dunn, Embrun (CA); Renato Dutra, Orleans (CA); John Wade, Orleans (CA); Steven Mangan, Gananoque (CA)

Correspondence Address: Dennis R. Haszko;Patent Law Office of D.R.Haszko, 499 MOSHER HILL ROAD, FARMINGTON, ME, 04938-5405, US

(73) Assignee: DAIRY CONTROLS INTERNATIONAL, INC., Summerstown (CA)

(21) Appl. No.: 11/538,433

(22) Filed: Oct. 3, 2006

Related U.S. Application Data
(60) Provisional application No. 60/812,108, filed on Jun. 9, 2006.

(51) Int. Cl. A01J 5/01

(52) U.S. Cl. 119/14.14

(57) ABSTRACT

An apparatus and related methods using photographic imaging and the interactions between light beams and dairy milk to provide in-line monitoring, analysis, and display of the quality of milk collected from dairy animals. The apparatus is robust in that it is reliable, simple to install, relatively small in size, cost effective, easily cleaned, and low maintenance. The apparatus can be installed directly in-line with the milk collection apparatus for each animal so as to measure the entire milk yield produced by that animal at flow rates typically used in milking parlours without requiring any unusual tube fittings or non-standard equipment. The apparatus is capable of handling analysis of a flow having mixed densities, air/liquid ratios, temperature variations, or any other similar variation of physical characteristics.

### CROSS-REFERENCE TO RELATED APPLICATIONS

This application claims the benefit of priority of U.S. Provisional Patent Application No. 60/812,108 entitled “In-Line Apparatus and Real-Time Method to Determine Milk Characteristics” filed Jun. 9, 2006, the contents of which are entirely incorporated herein by reference.

### FIELD OF THE INVENTION

The present invention relates generally to on-farm dairy milk analysis. More particularly, the present invention relates to a method and apparatus for in-line monitoring, analysis, and display of the quality of milk collected from dairy animals (cows, goats, sheep, etc.) during the milking process using

### BACKGROUND OF THE INVENTION

In the field of dairy farming, milk quality is a constant concern. The industry partners and consumers demand high quality milk free from contamination. Milk pricing is based on test results indicating cleanliness and percentage of components, both on an individual animal basis and collectively. For the lack of technological know-how, these evaluations are performed off the farm at great expense to the farmer in terms of time and money. It would be beneficial to perform these tests while the milk is being delivered. Animals arriving at the milking parlour, especially cows, may have developed mastitis infections or other disease or injury. In severe cases the milking equipment operator may observe symptoms that allow for a diagnosis and diversion of the contaminated milk collected from the symptomatic animal into a waste stream. In many cases however, animals with significant levels of foreign bodies in their milk such as blood or so-called mastitis flakes, present no external symptoms as the disease or injury has not yet advanced to that degree.

Dairy installations such as milking parlours often combine the milk collected from several animals into a single, main stream providing the risk for contamination of a large volume of high quality milk by the milk collected from a single injured or infected animal. Furthermore, the entire milk yield collected from an animal is delivered into the system in a short time, of the order of five minutes. It is highly desirable that methods and instruments for measuring milk quality have rapid response times so that effective action may be quickly taken. For example, the contaminated milk may be diverted from the high-quality main stream in time to prevent mixing of high-quality and contaminated milk.

Current methods and apparatus for detection of infections in milk rely on rendering the associated somatic cells in the milk visible or fluorescent by the addition of a dye or similar substance to the milk. This is undesirable as it results in contamination of the milk with the foreign substance in question and requires that a consumable indicator be available whenever a measurement is required. One known method is discussed in a publication “Near-Infrared Spectroscopy for Dairy Management: Measurement of Unhomogenized Milk Composition” by Tsenkova et. al., 1999 J Dairy Sci 82:2344-2351.

In order to provide the most accurate estimate of the foreign body sizes and relative concentrations in the milk, real-time, direct measurement of the size of the bodies is desirable as well as a large number of sample measurements for the milk yield extracted from each animal. Often, automation is utilized to facilitate such large number of samplings. However, the trend to use more automation, particularly milking robots, is impeded by the requirement that cows be inspected for mastitis visually by an operator. If the apparatus and method can replicate the function of a human operator this impediment can be overcome. As mentioned, current detection of infections in milk rely on rendering the associated somatic cells in the milk visible or fluorescent by the addition of a dye or similar substance to the milk. The concentration of somatic cells, which may be correlated to the degree of infection in the animal, may be estimated by the intensity or other characteristic of a fluorescent or similar signal emitted by the sample when it is irradiated with light of the appropriate wavelength, for example. Attempts to reduce the response times of methods or instruments for the detection of infections in milk within the prior art have included the development of sampling cartridges that incorporate the dye or fluorescent material, which may be used in conjunction with automated, portable fluorescence analyzers.

Further, milk's inherent normal characteristics are also of considerable interest to the dairy industry. The efficiency or other desirable attributes of the processes of dairy industry clients are sensitive to the relative concentrations of various components of the milk such as fat. The concentration of fat in the milk has been estimated by a number of known methods in the dairy art. These have included the measurement of propagation times of signals of differing frequencies.

Attempts to reduce the costs of known methods have been limited to conventional means such as test process automation. Oftentimes, such known methods provides for the diagnosis of contamination of the main milk stream by testing with consumable materials, but at the penalty of testing only a small sample of the yield from each animal, or by diverting that yield from the rest of the milk flow by the use of special equipment and procedures. To date, no prior art exists for the direct measurement of foreign body size in a milking parlour system, or for the potential to collect a large number of samples data points for each milk yield. Moreover, no prior art exists for detecting foreign bodies or disease indicators in milk without diverting a portion of the milk from the main flow of the yield. Current methods for detection of infections in milk are therefore limited.

Current methods can produce a result correlated to the somatic cell concentration. This result is not correlated to the foreign body size frequency distribution or total volume in the milk. Moreover, response times for the detection of infections in milk within current methods can be 45 seconds or more, which is inadequate to allow timely decisions on diversion of the yield from an injured or infected animal to waste, or to dilution in the rest of the milk volume from the healthy animals, etc. Using current methods, it is not readily possible to reduce the cost of prior art instruments to the level that would permit the detection of indicators of disease such as mastitis at every milking station in a significant proportion of all milking parlours. Known mastitis detection methods and instruments have not addressed the intrinsic problems of contamination and sampling, relying as they do on the use of consumable materials. Such known methods provide neither a direct measure of foreign body size nor the potential to collect a large number of samples owing to the inherently long response time. Still further, such known methods for detecting foreign bodies or disease indicators in milk require that a portion of the milk be diverted from the flow.

It is, therefore, desirable to provide a robust method and apparatus for real-time assessment of milk quality during dairy production.

### SUMMARY OF THE INVENTION

It is an object of the present invention to obviate or mitigate at least one disadvantage of previous dairy industry methods for milk analysis. The present invention provides great benefit to the milk industry in regard to test results indicating cleanliness and percentage of milk components, both on an individual animal basis and collectively. The present invention performs these tests while the milk is being obtained on the farm, resulting in advantageous reduction in expense to the farmer in terms of time and money.

The present invention seeks to provide for an apparatus used in the dairy industry that is robust, reliable, simple to install, small in size, cost effective, cleanable (using no more hot water or chemicals than to clean than milking pipe lines), low maintenance, and suitable for low line and high line systems. The present invention desirably includes a sealed apparatus that can be located vertically in-line without any moving parts. While vertical mounting is discussed, it should be understood that any other orientation such as horizontal mounting is possible without straying from the intended scope of the present invention. The present apparatus and associated method may be installed directly in-line with the milk collection apparatus for each animal so as to measure the entire milk yield produced by that animal at flow rates typically used in milking parlours, though requiring no unusual tube fittings or non-standard equipment. Such typical flow rates exist in a manner where there is a mixed flow of milk—i.e., a flow having mixed densities, air/liquid ratios, temperature variations, or any other similar variation of physical characteristics. While a mixed flow is discussed herein, it should further be understood that analyzing a more consistent flow may be possible where an upstream buffer can exist to ensure a filled tube where sensing occurs rather than partially or incompletely filled as in a mixed flow.

For purposes of describing the present invention, the terms milk yield and milking parlour are defined as follows. Milk yield is the volume of milk collected from a single animal during a single milking. Milking parlour is an array of milking equipment used to collect the milk from several animals simultaneously and combine the resultant milk flows into a tube leading to a reservoir for subsequent transport to a milk food processing facility. It should be understood that the term milking includes collecting the milk from all available animals. It should further be understood that a cleaning, or flushing, of the system would of course be desirable so as to enhance the veracity of analysis.

In a first aspect, the present invention provides an apparatus for real-time determination of milk characteristics, the apparatus including: an input for accepting a mixed flow of milk; an output for providing the mixed flow of milk to dairy processing; a photographic element for obtaining intermittent photographs of the mixed flow of milk; a temperature sensing element for obtaining continuous temperature readings from the mixed flow of milk; and a pair of light (such as, but not limited to, NIR) emitters and corresponding detectors for obtaining volume and fat readings from the mixed flow of milk.

In a further aspect, there is provided a method for real-time determination of milk characteristics, the method including: providing a mixed flow of milk within a sensing area located in-line with dairy processing; photographically analyzing the mixed flow of milk within the sensing area in an intermittent manner so as to detect quantifiable milk characteristics; obtaining temperatures within the mixed flow of milk in a continuous manner so as to determine real-time milk temperature in the sensing area; obtaining volume readings of the mixed flow within the sensing area; obtaining fat readings of the mixed flow within the sensing area; and based upon the quantifiable milk characteristics, the real-time milk temperature, the volume readings, and the fat readings, establishing an overall quality of the mixed flow of milk. While photographically analyzing the mixed flow of milk may occur intermittently, it should be understood that such sampling behavior may be replaced with continuous data coverage without straying from the intended scope of the present invention.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is a perspective view of an embodiment of the apparatus in accordance with the present invention.

FIG. 2 is a schematic of milk flow through the embodiment of FIG. 1 showing detecting elements of the invention.

FIG. 3 is a block diagram illustrating the processing and user interface components in accordance with the present invention.

FIG. 4a is a schematic of a cross-sectional view taken along the axis of milk flow.

FIG. 4b is a schematic of a cross-sectional view taken across the milk flow axis.

### DETAILED DESCRIPTION

Generally, the present invention provides a method and apparatus for real-time determination of milk characteristics in-line during the dairy process.

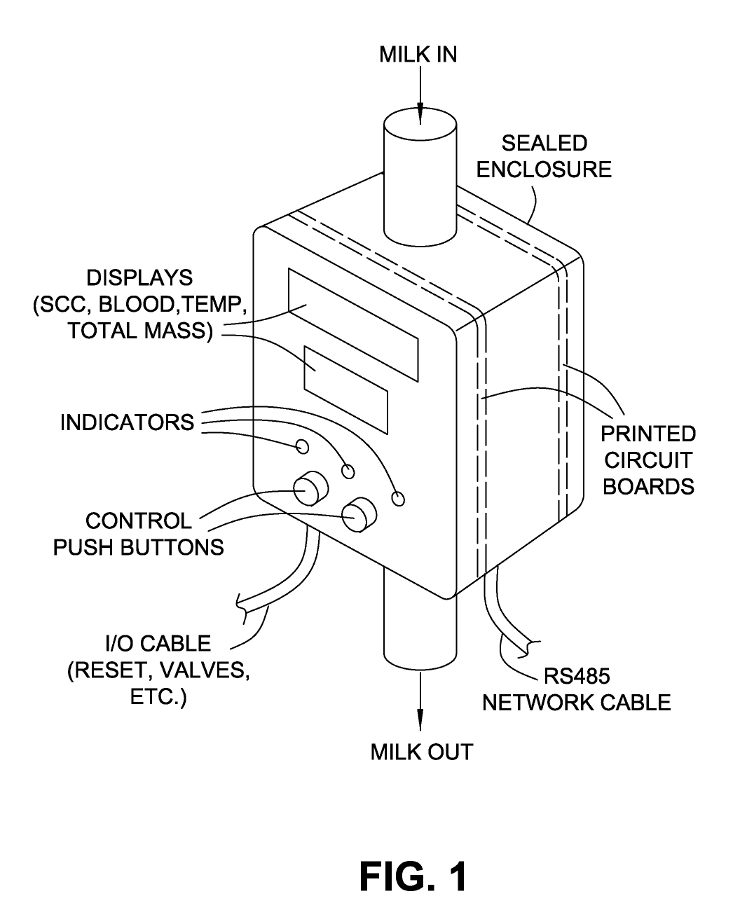

As shown in FIG. 1, the apparatus of the present invention includes detecting, processing, and user interface components housed within a sealed enclosure. Due to the placement of the apparatus in the dairy setting, all materials used should be appropriate for proper hygiene. That is to say, stainless steel, food grade plastics and similarly easily cleaned surfaces are preferred materials for use in fabricating the sealed enclosure.

The apparatus in accordance with the present invention includes an input port and an exit port for milk flow therethrough. While cow milk is discussed herein, it should be understood that any milking process within the dairy industry might be involved including milking of goats, sheep, or any suitable dairy stock.

The apparatus includes internal circuitry used to sense and analyze the milk flowing through the apparatus. Printed circuit boards embody the circuitry and related components discussed further hereinbelow. A display feature provides real-time data output indicating somatic cell concentration (SCC), blood temperature, total mass, or any other relevant characteristic determined by the internal circuitry. The display may be in the form of any screen that suitably conveys the information to a dairy worker, and may include one or more liquid crystal displays (LCD) or light emitting diodes (LEDs) with alphanumeric indication. Remote displays are possible through wired or wireless technology. Further, provisions for grouped display banks showing information from multiple apparatus used in series within a milking parlour is also within the scope of the present invention.

The apparatus also includes indicators in terms of one or more LED or similar lighted indicators alone or in combination with audio alarms such as via piezoelectric devices. Such indicators may be used to show off/on activation, apparatus status, fault situations, or any such similar operating characteristic.

The apparatus also includes suitable input/output cable(s) for apparatus reset, valve actuation, or any like operation. For centralized computing analysis, a networking cable (e.g., RS485) may be provided for central data gathering or networking of one or more apparatus.

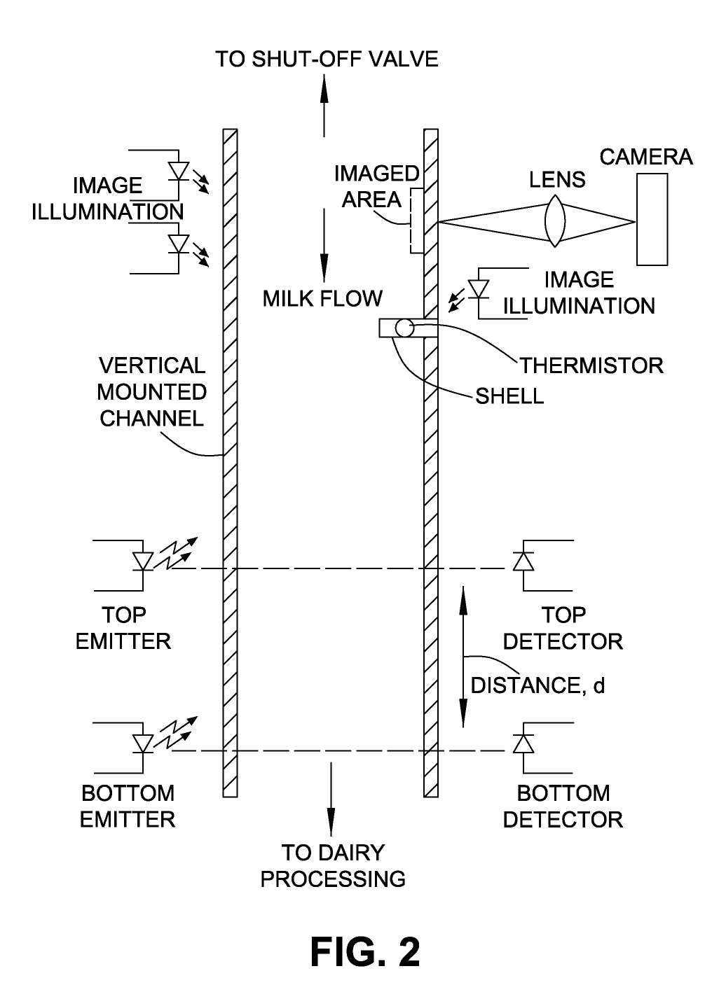

FIG. 2 is a milk flow schematic illustrating the circuitry and electronic components of the apparatus. In general, the present invention includes a vertical channel for flow-through of milk that defines a sensing area. It should be readily apparent that the sensing area is considered to be a volume that includes milk to be sensed and analyzed. The vertical channel may be a rectangular cross-sectional, of similar area to milk piping and fabricated from material that is optically and near infrared (NIR) transparent. The channel has an imaging area that is a flat, transparent, smooth window for imaging. A camera, lens, and illumination mechanism (e.g., LED) is provided in a manner so as to optically detects somatic cell (SC) flakes/particles and blood within the milk flow. Paired emitters and detectors are arranged adjacent the milk flow so as to measure low volume and fat. Such emitters and detectors can be the NIR type including, but not limited to, LEDs and infrared (IR) laser diodes. If necessary, the NIR emitters may include IR filters to operate in the desired wavelength—e.g., 880 nm to 950 nm range. Temperature measurement of the flow is accomplished through use of a thermistor.

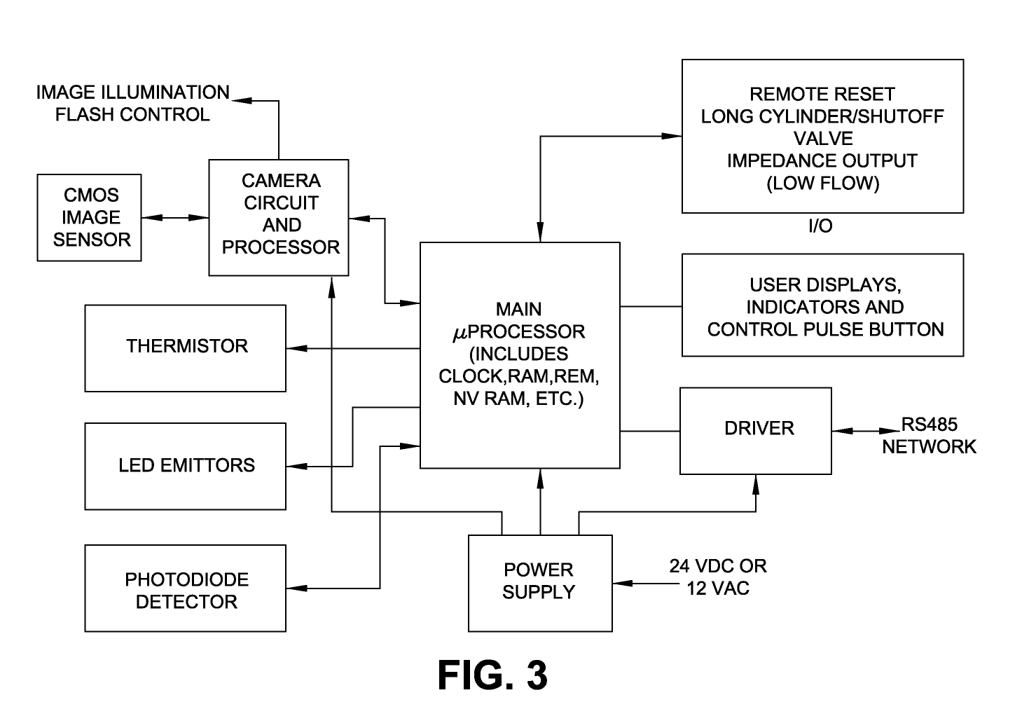

FIG. 3 is a block diagram illustrating the processing and user interface components in accordance with the present invention. A main microprocessor block is shown coupled to a power supply block of 12V DC or 24V AC power. In off-grid applications, a battery supply may be possible with a suitable current converter. The power supply block supplies the main processor, network driver, and the camera circuit/processor. The main processor includes an input/output (I/O) connection with the camera circuit/processor, which, in turn, is connected with the image illumination control, and CMOS image sensor. The image illumination may be for flash illumination or any other suitable manner of illumination including, but not limited to, continuous illumination if continuous photographic monitoring is used instead of intermittent sampling. The main processor is also operationally connected with the temperature sensing thermistor, NIR emitters, and photodiode detectors. The main processor also includes an I/O connection for removing resets, shutoff valve actuation, and an impedance output indicating low flow. The user interface including the displays, indicators, and manual control buttons/switches are also operationally connected to the main processor. The network driver is connected to an RS485 communication port for network communications.

The main processor measures depth (i.e., into the sensed area), velocity and fat content, calculates instantaneous flow rate, interrogates camera processor for status, totalizes volume, calculates flow mass, calculates SCC and blood concentrations, measures and holds, highest milk temperature, handles network communications, reads and controls I/O, and provides user interface functions.

In operation of the apparatus, the present invention includes methods for determining important milk production characteristics through analyses including detection and analysis of somatic cell flakes and foreign bodies, blood concentration in milk, milk protein content by volume in milk, milk fat content by volume in milk, instantaneous milk temperature, and instantaneous milk flow rate.

In terms of the detection of somatic cell flakes or foreign bodies and size frequency distribution in milk, the presence of foreign bodies in the milk may be realized by a variety of optical techniques. For example, a 1-dimensional or 2-dimensional array of photodetectors may be used, with appropriate lighting of the milk flow, with or without lenses, to detect the change in signal intensity when an object that changes the light intensity transmitted through or reflected from that portion of the milk passes before one of more elements of the array. One such illustration of this embodiment of the invention is a camera that captures and image of the milk flow using light that has passed through a relatively thin, semi-transparent milk layer on the wall of a transparent tube. By appropriate selection of the lens type, lens to tube distance and lens to sensor distance, the desired magnification and resolution may be achieved. It should be readily understood by one skilled in optical technology that the use of an electronic camera and appropriate signal processing devices and software allow for a rapid indication of the presence of foreign bodies in the milk, with size frequency distribution, and for related action by the operator or automated milking system before the contaminated milk has entered the combined flow from multiple milking stations.

In terms of the detection of blood and concentration measurement in milk, the presence of blood in milk may be detected via the color change that results from the mixing of red blood with white milk. Although, in principle, an optical sensor using principles similar to those described for the measurement of fat concentration herein may be realized, it is difficult to deliver reliable results in the face of varying milk layer thicknesses present in real milking parlour flows. A camera (i.e., an optical device that uses one or more lenses to collect an image onto a photosensitive surface) that renders sufficiently accurate color information may be used, with appropriate lighting of the milk flow, to capture images of the milk flow surface, or the light which has traversed a thin, partially transparent milk film may be collected by the camera. Subsequent processing of the photographic or electronic images, with adequate controls of color signal fidelity, may allow for reliable detection of the presence of blood in solution in milk down to levels well below 1% by volume. It should be readily understood by one skilled in optical technology that the use of an electronic camera and appropriate signal processing devices and software allow for a rapid indication of the presence of blood in the milk, with a concentration estimate, for action by the operator or automated milking system before the contaminated milk has entered the combined flow from multiple milking stations.

In terms of relative measurement of protein concentration, the protein concentration exploits the fact that the protein particles in milk are smaller in size than the fat globules or other structures. A significant proportion of the protein content is assembled into so-called micelle structures, with sizes ranging from approximately 10 nm to approximately 500 nm in diameter. By contrast, the fat globules occur in sizes ranging from approximately 100 nm to approximately 10 μm in diameter. Thus, optical phenomena for which the signal intensity depends on the size of the particles, such as scattering at appropriate wavelengths, may be used to measure the relative concentration of different sizes of protein micelles, fat globules, etc.

The present invention may use the combining of the measurements to yield additional results. Firstly, the measurement of fat concentration may be combined with the milk flow thickness signals so as to correct for milk film thickness measurement, and hence flow volume, errors introduced by the variation in fat concentration during the milking, with animal breed, season, and so on. Secondly, the foreign body size distribution measurement may be combined with the total volume measurement for a given milk yield to estimate the volume particle concentration in the yield. This value may be displayed to the operator or delivered to the automated monitoring system. The concentration value may be used to determine the action to be taken concerning the milk yield and/or animal in question. Thirdly, the relative measurement of protein concentration may be combined with the total volume and fat concentration measurements (as described further hereinbelow) to deliver an absolute protein concentration result for the milk yield in question.

In terms of the measurement of fat concentration in milk, the present inventive method for the measurement of fat concentration exploits the fact that the difference in absorbance or transmittance of a milk film sample at appropriately chosen wavelengths will vary as a function of the fat content. Thus, if two light beams of different, selected wavelengths traverse the same optical path of a milk sample and appropriate detectors measure the signal intensities, the fat content will be proportional to the ratio of the calibrated signals from the two detectors. For example, in cow milk, the greatest absorbance ratio difference for which simpler and more reliable electronic devices are available is seen between wavelengths in the 905 nm to 930 nm range and at 1450 nm. The values are tabulated below.

| | Wavelength | Wavelength |
|---|---|---|
| | 905 nm | 1450 nm |
| A {= log (1/T)} for 0.78% fat | 1.1 | 1.9 |
| A {= log (1/T)} for 6.48% fat | 1.3 | 2.75 |

Thus, the signal strengths for the two detectors at 0.78% fat would vary by 10^{0.8}, or a ratio of 1:6.3. The signal strengths for the two detectors at 6.48% fat would vary by 10^{1.45}, or a ratio of 1:28. The use of this information in a look-up table or calibration curve allows direct estimation of the fat content in real time or with sufficiently low delay time as to be useful in the on-line application. It should be readily understood by one skilled in optical technology, after examination of the relevant milk spectral curve plots, a large variety of optical path configurations, wavelengths, source types as well as the numbers of emitters and detectors may be applied to realize a wide range of accuracy and cost results.

In terms of milk temperature measurement, the milk temperature is measured throughout the milking by means of a temperature sensor. The temperature sensor may be a thermistor located in the milk flow. Such thermistor would be mounted in a stainless steel or similar housing. The thermal impedance between the thermistor and the milk being sufficiently low as to provide rapid and accurate measurements of the true milk temperature. The temperature profile and peak temperature are key parameters that are used to determine milk animal health and abnormal milk.

In terms of instantaneous milk flow determination, the present invention uses NIR sensors to determine the average milk depth at one plane orthogonal to the milk flow direction and the average velocity of the milk across this plane. In the vertically mounted embodiment described herein, this would of course determine the average milk depth at one horizontal plane in the channel and the average velocity of the milk across this plane. The milk depth is related to the IR absorption. Because of the nature of the milking system, milk flow is irregular and so flow velocity can be determined by comparing the upper and lower detector outputs to measure the phase shift. Average milk velocity between the upper and lower detector signals is equal to the distance between the upper and lower detectors divided by the phase difference between the upper and lower detector signals (i.e., the time taken for the milk to pass through). The flow rate in volume is then the product of cross sectional milk area (depth x transparent tube effective width) and velocity. It should be understood that the transparent tube forms the channel in which sensing occurs. Flow rate in mass is then given by the product of the flow rate in volume and the density of milk.

Flow is sensed using NIR emitters and detectors. However, laser diodes, photodiodes, or any similar suitable device may be used for the emitter or detector as appropriate. The wavelength used is preferably 880 nm and is selected to be minimally affected by variation in fat content. Wavelengths at 950 nm may be needed in order to calculate fat and measure depth. Infrared (IR) filters may be used in conjunction with IR emitters to enable use of such wavelengths at 880 nm and 950 nm. Alternatively, laser diodes may be used in which such instance no IR filters would be needed. Six emitter/detector pairs may be used with three located across the channel (Upper) and another three located preferably 25 mm below these also located across the channel (Lower). This 25 mm spacing is selected to balance sampling speed and correlations per second. The emitters and detectors are selected to a narrow a spectral response. NIR guides are used to minimize cross talk across the channel. Such guides may be formed as light pipes, or baffles, between the emitters and detectors so as to minimize cross talk between adjacent emitter/detector pairs. Photodiodes are used as detectors. A linear current to voltage conversion signal conditioning circuit is used. The detector output is smoothed by a simple resistor-capacitor (RC) filter with a time constant of about 30 μs. The IR intensity at each detector is sampled at a rate of approximately 3 ksamples/s with a 12-bit resolution.

To increase the effective resolution of the sampled signal, two gain levels may be used, one for incident intensity (no milk) and one for transmitted intensity (milk present). The emitters should be located close to the exterior channel surface and the detectors 12 mm from the other side of the channel exterior surface so as to reduce transmitted intensity variation with position across the channel. To minimize power consumption, it should be understood that the IR emitters are turned off when not required.

Theoretically, the cross sectional depth (d) is given by:

d=−(10/OD)*log(I/Iₒ)

### Where:

D—Cross sectional depth
OD—Optical Density and is approx 1.5 db/mm for 4% fat whole milk
I—Intensity of transmitted IR radiation.
I—Intensity of incident IR radiation.

Or alternatively this can be written as,

I/Iₒ=10^{((-d*OD)/10)}

The intensity of the incident IR radiation is measured at a detector with a film of milk on each channel wall. Such measurement is the detector intensity with milk film. The incident intensity may be recalibrated between each cow, except for the first, when data stored from the last cow of the previous milking will be used. It should be readily apparent that appropriate software would control data storage and retrieval such and tracking of cows (i.e., first to last cow). To determine milk depth the average of the upper three emitter/detector pairs is used. The depth is determined by averaging each of the three upper photodiode outputs (proportional to intensity) over the flow calculation period, then determine the average depth for each detector, then averaging the depth of the three detectors. Such measurement is the average detector intensity.

Upper Milk Depth (50 ms) average=(10/OD)*log 10(Detector Intensity with milk film/Average detector intensity)

The OD value used is determined by the fat content. For example, a fat percentage in the range of 3.5 to 4.5 would involve an OD value of 1.3 db/mm. Other OD values can be determined for other fat percentages.

To determine milk velocity in the milk channel the signal of each upper detector is correlated with the signal from the respective lower detector. The highest value (R2) of the three correlations is then selected to determine the phase difference. If the best correlation is less than 0.5, then the phase difference obtained in the preceding cycle is used.

The correlations are performed using 300 samples (100 ms) of the upper detector, and 150 samples (50 ms) of the lower detector. With the upper samples starting at t=0, and the lower samples starting at t=50 ms. The correlations (132 are required) are then performed and the highest correlation (and the respective phase this represents) selected. At a flow rate of 4 m/s this sample rate gives a resolution of ±5%, at 2 m/s it will be 2.5%, at 1 m/s it will be 1.25%.

It should be noted that as the milk flows between the upper and lower detectors, it accelerates due to gravity (in the vertical implementation). Because the flow rate does not change as the milk moves down the pipe and as the flow velocity at the upper detector is less than the lower detector, the milk cross sectional depth will be at greater the upper detector relative to the lower detector. This effect is compensated for when calculating flow rate.

The relationship to lower velocity (vᵤ) to upper velocity (vₗ) is:

vₗ=(2gl+vᵤ²)^{0.5}

Where:

g is acceleration d due to gravity (9.8 m/s)
l is distance between upper and lower sensors (0.025 m)

Average velocity=(vₗ+vᵤ)/2

Also, average velocity=l/t

Where:

t is time travel from the upper to the lower points.

### Thus,

vᵤ=[{(2l/t)²−2gl}/4l/t]

So in this case, the Upper Velocity=(0.025/t)−4.9 t

The rate of flow mass is calculated every 50 ms. Flow Rate (Mass)=Upper Velocity*channel width * Average upper milk depth*Whole Milk Density)

Where:

Whole milk density is 1030 kg/m3

The total mass is updated every 50 ms as follows:

[(Flow Rate in Mass)/20)+Previous total mass]*Correction Factor

Where the Correction Factor is determined by experimentation and is common to all flow meters of the same model type. In free fall at sea level, this may need empirical correction during testing as it is an over simplification. The reasons are that (1) the milk is contact with the channel wall thus slowing it down and (2) the milk surface has air passing over it at a higher velocity than the milk thus speeding it up.

Alternative embodiments of the present apparatus may include a plurality of cameras located in different planes to determine flow volume. As well, embodiments of the present method may include flow measurement using one or more cameras and instantaneous milk flow determination using a plurality of cameras. Further, the fluid flow velocity, volume flow rate and total volume over elapsed time may be directly measured, or estimated to a desired degree of accuracy, using a variety of techniques that apply imaging devices such as cameras, in conjunction with electronic data processors.

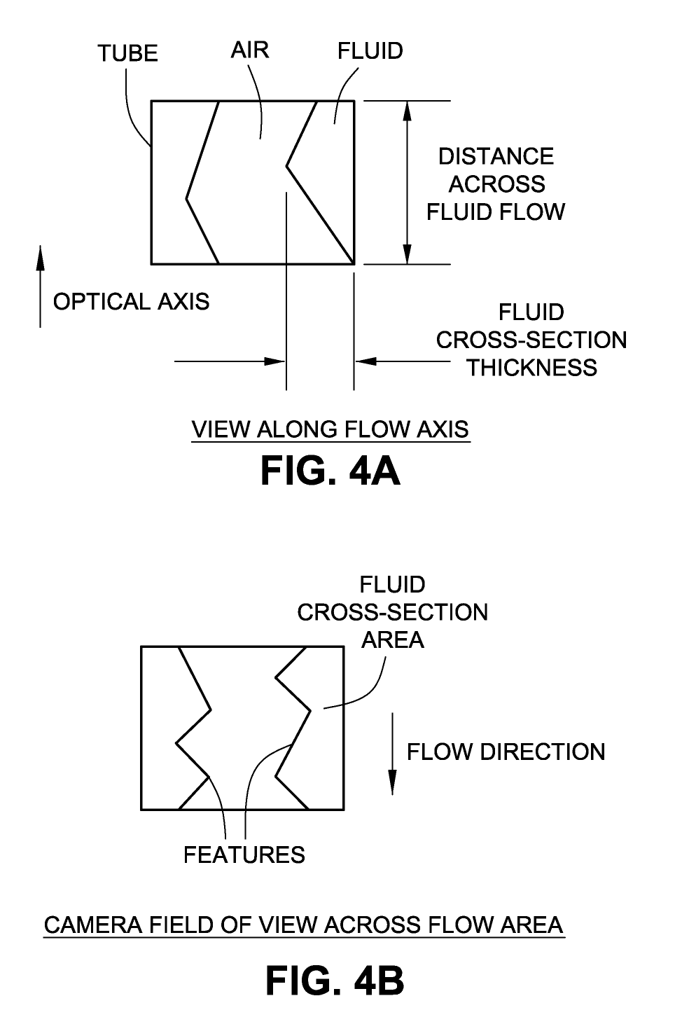

FIG. 4a is a schematic of a cross-sectional view taken along the axis of milk flow, whereas FIG. 4b is a schematic of a cross-sectional view taken across the milk flow axis. The cross-sectional area of fluid in successive images of continuous video data may be estimated and the volume flow rate (volume per unit time) calculated from the image cycle time. Alternatively, the transit time of features in the fluid flow mass, such as changes in the thickness(es) of the fluid layer(s) measured from the wall(s) of the tube or conduit, air bubbles, etc. may be used to estimate the flow velocity (distance per unit time)

One embodiment of these inventive techniques is the use of one or more electronic cameras to capture images of the milk flow thickness in cross-section from one or more surfaces of known profile, e.g., a flat plane, through the walls of a transparent tube or conduit, or transparent windows in an opaque tube or conduit. In a relatively straightforward design, a single camera can deliver a video signal for processing in which the images are continuous, that is there are no gaps between images corresponding to time periods when the fluid was flowing but no image was captured. The area of fluid in each image is measured by counting the corresponding image pixels and applying the known magnification factor. The distance across the fluid flow (along the optical axis) is known and thus the volume estimate for one image and the flow rate for a single image are given by:

Image volume=(Fluid area×Distance across the fluid flow).

and

Flow rate=(Fluid area×Distance across the fluid flow)/(Image cycle time).

The total volume that has flowed past the camera field of view during a time period of interest is obtained by summing the appropriate number of single image volume values.

A second embodiment of these techniques also includes the use of one or more electronic cameras to capture images of the milk flow thickness against one or more tube or conduit surfaces of known profile, e.g., a flat plane. The position of features in the fluid flow in successive images may be measured by counting the number of pixels between the positions in the successive images and applying the known magnification factor. The elapsed time between images is known and hence the velocity may be estimated.

In a design such as the first embodiment above, the camera will deliver a video signal for processing in which the image sequence is continuous, that is there are no gaps between images corresponding to time periods when the fluid was flowing but no image was captured. In practice, the signal processing power and expense required to continuously analyze video images to measure the flow velocity is currently difficult to realize and also too expensive for an instrument that is to be installed at every milking station. There are several methods that may be applied to address this practical problem.

In one method, it is sufficient to apply the processing power of a single processor and associated hardware and software that is affordable to successive pairs of images, and use an averaging function to estimate the flow velocity for the time period between measurements when the processor is analyzing the preceding image pair. The sequence of events includes: the capture of a first image by the camera device; transfer of the data corresponding to the first image from the camera device to the processor for analysis; capture of the second image by the camera device; completion of the analysis of the first image by the processor; transfer of the data corresponding to the second image from the camera device to the processor for analysis; completion of the analysis of the second image by the processor; comparison of the two images to detect and measure the distance between features that have translated to different positions between the two images; start of the next cycle. It is evident to one versed in the art that a variety of processing and storage devices may be arranged in a number of configurations with a variety of algorithms and software applications to arrive at the desired speed of analysis, accuracy, cost, etc. One variation of this method would use more than one processor, the images being analyzed in tandem, rather than in a serial fashion.

In this method, the time period requirement between images in a pair, to ensure that features in the first image are also in the second image, is given by:

Time between images≦(Camera field of view length along flow direction)/(Flow velocity)

While there are a vast number of solutions to this expression that may be applied to different designs, we may illustrate the scale of the time between images in a pair by selecting an averaged flow velocity of 1 meter per second and a camera field of view length of 10 mm. In this example, the time between images must be less than or equal to 0.01 seconds.

In a second method, which may be applied when the design criteria for the instrument do not support the short time interval between successive images, two or more camera devices may be arrayed along the flow direction. The image processing is applied in a similar fashion as described for the first method, but in this case:

Time between images≦(Distance between camera fields of view along flow direction)/(Flow velocity).

The spacing between the camera devices may be significantly larger than one image length, and hence the time interval between images in a pair may be extended, however the designer must ensure that, given the flow dynamics of her individual instrument design, the features captured in an upstream camera are sufficiently stable as to remain visible until their arrival in the field of view of the second camera.

In a third method, the transit time across the individual field of view of one or more cameras during a single image cycle time may be measured. For any given camera, the field of view may be segregated by applying appropriate delay times to the transfer of data from different lines or zones of pixels oriented across the flow direction. The image processing is applied in a similar fashion as described for the first method. If the field of view has been segregated into N zones along the flow direction, then the delay time between the read-out of the different zones to ensure that features in a zone are also in the successive zone, is given by:

Zone delay time=(Camera field of view length along flow direction)/(Flow velocity×N)

It should be readily apparent that, as a penalty for reducing the cost of processing power, etc. in this method, the effective length of the field of view along the flow direction for each camera has been reduced to 1/N of the full value. However, this method may be particularly useful when the design constraints require that a single camera is used and it is not possible to transfer image data from the camera at a sufficient rate to meet the requirements of the Zone Delay Time equation above.

A fourth method addresses the potential for error in the estimate of flow rate due to variations in the fluid cross-section thickness along the optical axis. In this method the cameras are mounted in pairs, with their axes and fields of view aligned to capture images of the same fluid flow length from opposite sides of the tube or conduit. The different fluid cross-section thickness and/or area estimates may be used, via an averaging function, to adjust the calculated values of volume flow rate, etc. that are otherwise based on the assumption that the thickness is constant along the optical axis.

Several of the above methods are applied to the flow thickness(es) imaged as cross-sections across a single plane, for example the two fluid flow surfaces visible in one image plane orthogonal to the relevant surfaces of a tube or conduit of rectilinear section. If the instrument design flow dynamics are such as to ensure that the fluid always accumulates against the surfaces of interest, or to ensure that the thicknesses on other surfaces that are not measured are related in a known, controlled fashion to the measured surfaces, this may provide acceptable accuracy for the measured and calculated values. If, however, it is not possible to confine the fluid against the surfaces where the relevant flow cross-sections are imaged in a single plane under all conditions of flow rate, fluid density, viscosity, etc., other example embodiments may be applied that use the techniques described above to measure the fluid flow thicknesses and/or areas from two or more intersecting image planes so as to arrive at the required degree of accuracy.

The algorithm(s) used to analyze the images must be designed to accommodate different potential sources of erroneous flow velocity values. For example, foreign bodies present in the milk may stick or drag against the tube surfaces and thus move at lower velocities than the fluid itself. Also, surface waves on the fluid/air interface may travel at different velocities than the fluid itself.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An apparatus for real-time determination of milk characteristics, said apparatus comprising:
an input for accepting a mixed flow of milk;
an output for providing said mixed flow of milk to dairy processing;
a photographic element for obtaining photographs of said mixed flow of milk;
a temperature sensing element for obtaining continuous temperature readings from said mixed flow of milk; and
a pair of light emitters and corresponding detectors for obtaining volume and fat readings from said mixed flow of milk.

2. The apparatus as claimed in claim 1 wherein said pair of light emitters are near infrared (NIR) emitters and at least said photographic element, said temperature sensing element, and said pair of NIR emitters and corresponding detectors are contained within said apparatus separate from said mixed flow of milk so as to preclude contamination of said milk.

3. The apparatus as claimed in claim 2 wherein said input and output are formed in a manner to facilitate in-line connection of said apparatus to standard dairy tubing.

4. The apparatus as claimed in claim 2 wherein said apparatus includes a main processor and at least said photographic element, said temperature sensing element, and said pair of NIR emitters and corresponding detectors are coupled to said main processor.

5. The apparatus as claimed in claim 4 wherein said apparatus includes a network driver coupled to said main processor for networking said apparatus to one or more dairy processing mechanisms external to said apparatus.

6. The apparatus as claimed in claim 1 wherein said photographic element obtains intermittent photographs of said mixed flow of milk.

7. The apparatus as claimed in claim 2 wherein said pair of NIR emitters further include infrared filters.

8. The apparatus as claimed in claim 1 wherein said pair of light emitters are laser diodes and at least said photographic element, said temperature sensing element, and said pair of light emitters and corresponding detectors are contained within said apparatus separate from said mixed flow of milk so as to preclude contamination of said milk.

9. A method for real-time determination of milk characteristics, said method comprising:
providing a flow of milk within a sensing area located in-line with dairy processing;
obtaining quantifiable milk characteristics from said flow of milk within said sensing area; and
based upon said quantifiable milk characteristics, establishing an overall quality of said flow of milk.

10. The method as claimed in claim 9 wherein obtaining quantifiable milk characteristic includes photographically analyzing said flow of milk within said sensing area so as to detect quantifiable milk characteristics.

11. The method as claimed in claim 10 wherein obtaining quantifiable milk characteristic further includes obtaining temperatures within said flow of milk so as to determine real-time milk temperature in said sensing area.

12. The method as claimed in claim 11 wherein obtaining quantifiable milk characteristic further includes obtaining volume readings of said flow within said sensing area.

13. The method as claimed in claim 12 wherein obtaining quantifiable milk characteristic further includes obtaining fat readings of said flow within said sensing area.

14. A method for real-time determination of milk characteristics, said method comprising:
providing a mixed flow of milk within a sensing area located in-line with dairy processing;
photographically analyzing said mixed flow of milk within said sensing area in an intermittent manner so as to detect quantifiable milk characteristics;
obtaining temperatures within said mixed flow of milk in a continuous manner so as to determine real-time milk temperature in said sensing area;
obtaining volume readings of said mixed flow within said sensing area;
obtaining fat readings of said mixed flow within said sensing area; and
based upon said quantifiable milk characteristics, said real-time milk temperature, said volume readings, and said fat readings, establishing an overall quality of said mixed flow of milk.

15. The method as claimed in claim 14 wherein said quantifiable milk characteristics includes a milk characteristic selected from a group consisting of: an indication of somatic cell flakes within said mixed flow of milk, an indication of foreign bodies within said mixed flow of milk, an indication of blood within said mixed flow of milk, and an indication of milk protein within said mixed flow of milk.
